(19) United States
(12) Patent Application Publication
(10) Pub. No.: US 2013/0265271 A1
(43) Pub. Date: Oct. 10, 2013

(54) METHOD OF REDUCING COMPUTATION OF PALM REJECTION BY PROJECTING TOUCH DATA

(71) Applicants: Jih-Ming Hsu, Hsinchu City (TW); Chin-Hua Kuo, Hsinchu City (TW)

(72) Inventors: Jih-Ming Hsu, Hsinchu City (TW); Chin-Hua Kuo, Hsinchu City (TW)

(73) Assignee: Silicon Integrated Systems Corp., Hsinchu City (TW)

(21) Appl. No.: 13/441,837

(22) Filed: Apr. 6, 2012

(51) Int. Cl. G06F 3/044

(52) U.S. Cl. 345/174

(57) ABSTRACT

A method of reducing computation of palm rejection by projecting touch data is disclosed, targeting the handheld devices. The method targets first at obtaining a difference array, followed by extracting maximum values of rows and columns of the difference array to obtain a row projection list and a column projection list respectively. By repeated implementing of mutual capacitance detection, ghost palm blocks can be wiped out from the multiple palm blocks. Once integrating with a local spatial boundary detection algorithm, the sensed signals of intended input located within a rectangular palm block yet beyond a real palm block are consequently detected. The computational algorithm of the palm rejection of this invention is successfully built into the touch panel controller due to its substantially reduced computation.

### BACKGROUND OF THE INVENTION

1. Field of the Invention

The present invention relates to a palm rejection method, and more particularly, the present invention relates to a method of reducing computation of palm rejection by projecting touch data.

2. Description of the Prior Art

Capacitive touch panels originated from the improvement of inferiority in enduring scrapes of resistive touch panels. The detection of touches by capacitive touch panels simply recognizes the alteration of static electric field. Among all the touch technologies, single touch capacitive, also known as surface capacitive, matures with popularity substantially and is also manufactured with ease. Compared with the single-touch type, projected capacitive type adopts single layer or multiple layers of patterned ITO, to form a detection matrix. In self-capacitance detection technology, the accompanied touch panel contains row electrodes 3 and column electrodes 4, shown in FIGS. 1A and 1B. Once a finger taps on the touch panel, the self-capacitance of the electrodes in the proximity will be lifted, which is the consequence of the accumulation of all the self-capacitances in parallel. As the self-capacitance for each electrode is detected, the control chip is ready to acquire the variances of capacitances of all electrodes. And the related prior algorithms are used to find out possible positions of the touches. Unfortunately, the way the variances of capacitance in the electrodes detected by self-capacitance approach would bring about ghost points, which makes the self-capacitance approach fail to identify precisely the real positions of two touches or more.

On the other hand, in mutual-capacitance detection technology, its panel contains a raw data matrix that is a grid formed by row electrodes 3 and column electrodes 4 carried with capacitances. Unlike the target to be detected in self-capacitive touchscreen is the capacitance variance of entire electrode, the mutual-capacitive touchscreen detects merely the capacitance variance at intersects of crossed column and row electrodes. Different from the detection of X+Y pieces of electrodes in the self-capacitance type where X, Y are numbers of electrodes of the raw data matrix, the mutual-capacitance detects capacitance of X. Y independent points of intersects of the crossed electrodes, and it does mean that the mutual capacitance is capable of detection of multiple touches.

Although the mutual capacitance is well suited to the detection of multiple touches, the implementing of the detection is practically harder than that of the self-capacitance type, and the mutual capacitance of each intersect has smaller capacitance variance value comparatively. Supposing that mutual capacitance is the only data to be applied, the advanced touch features like those realized by the touch pen are unlikely being supported. Furthermore, the prior technologies in computation of palm rejection are sizable, and still not available to be built into the touch panel control chip.

Accordingly, it is known from the capabilities and inefficiencies of the prior art that the self-capacitance approach is limited in the detection of multiple touches while the mutual capacitance is smaller detected data than the self-capacitance. It was also reasonable to infer that the detection is once combined by the mutual capacitance with local spatial boundary detection algorithm, the computation of palm rejection would be substantially reduced, which then will be available for the computational algorithm of palm rejection to be built into the touch panel control chip.

### SUMMARY OF THE INVENTION

The objective of the present invention is to provide a method of reducing computation of palm rejection by projecting touch data, targeting the handheld devices. The method targets first at obtaining a difference array, followed by extracting maximum values of rows and columns of the difference array to obtain a row projection list and a column projection list respectively. By repeated implementing of mutual capacitance detection, ghost palm blocks can be wiped out from the multiple palm blocks. On the other hand, the zone to be rejected for a real palm block is a rectangle; therefore, any sensed signals of intended input fallen within the rectangular palm blocks yet beyond the real palm blocks are rejected together. By means of integration with a local spatial boundary detection algorithm, the sensed signals of real input located within the rectangular palm blocks yet beyond the real palm blocks are consequently detected. Due to the sizable reduction of the computation of the present method, the computational algorithm of the palm rejection can be built into the touch panel control chip.

To achieve the aforementioned objective, the present invention provides a method of reducing computation of palm rejection by projecting touch data, suited to the handheld devices, and the sizable reduction of computational algorithm of palm rejection is available to be built into the control chip of the touchscreen. The method comprises the following steps: obtaining capacitance raw data of a sensing array having row sensing lines and column sensing lines; comparing the capacitance raw data with reference raw data to obtain a difference array; obtaining a row projection list by extracting maximum values of rows the difference array; and obtaining a column project list by extracting maximum values of columns of the difference array.

In an embodiment of this invention, the current raw data of the sensing array are obtained by measuring self-capacitances of the respective row sensing lines and the respective column sensing lines.

In an embodiment of this invention, the current raw data of the sensing array are obtained by measuring mutual capacitances between the row sensing lines and the column sensing lines.

In an embodiment of this invention, the reference raw data comprises a capacitance matrix computed by a statistic model under a condition that no touch or palm block event occurs on the sensing array.

In an embodiment of this invention, the reference raw data is computed by using a static calibration procedure.

In an embodiment of this invention, the reference raw data is computed by using a dynamic calibration procedure.

In an embodiment of this invention, the method further comprises a step of determining at least one rectangular palm block by the row projection list and the column projection list.

In an embodiment of this invention, the step of determining at least one rectangular palm block by the row projection list and the column projection list is to compare the row projection list with a first palm threshold and compare the column projection list with a second palm threshold respectively to form a row palm mask and a column palm mask to determine an extent of the palm block.

In an embodiment of this invention, the corresponding row palm mask or column palm mask equals to 1 if a sensed signal of a sensing line in the palm block exceeds the palm threshold; otherwise, the corresponding row palm mask or column palm mask equals to 0 if a sensed signal of a sensing line in the palm block lowers than the palm threshold.

In an embodiment of this invention, if the number of the adjoined row sensing lines in the palm block is greater than a row-threshold and the number of the adjoined column sensing lines in the palm block is greater than a column-threshold, the sensed signals generated in the palm block are filtered out or neglected.

In an embodiment of this invention, the number of the adjoined row sensing lines in the palm block multiplied by the number of the adjoined column sensing lines in the palm block is greater than an area-threshold, the sensed signals generated in the palm block are filtered out or neglected.

In an embodiment of this invention, further comprising a step of filtering out ghost palm blocks from the rectangular palm blocks one after the other, which is accomplished by filtering out ghost palm blocks from the plurality of palm blocks by means of mutual capacitance detection.

In an embodiment of this invention, further comprising: detecting the sensed signals fallen within the rectangular palm blocks yet beyond real palm blocks by means of combining a local spatial boundary detection algorithm.

The advantages of the realization of the present invention comprise: detection of multiple palm blocks while rejection of the ghost palm blocks. Moreover, any sensed signals of the desired input fallen within the rectangular palm blocks yet beyond the real palm blocks can also be detected by integrating with a local spatial boundary detection algorithm. The computational algorithm of the palm rejection of this method can be successfully built into the touch panel control chip.

This invention is detailed described with reference to the following preferred embodiments and the accompanying drawings for better comprehension.

### BRIEF DESCRIPTION OF THE DRAWINGS

FIG. 1A is a schematic diagram of the raw data matrix of a touchscreen constructed by bar-type sense elements of prior techniques;

FIG. 1B is a schematic diagram of the raw data matrix of a touchscreen constructed by diamond-type sense elements of prior techniques;

FIG. 2 is a flowchart of the method of reducing computation of palm rejection by projecting touch data of a preferred embodiment of the present invention;

FIG. 3 is a schematic diagram of the raw data matrix detected by self-capacitance of a preferred embodiment of the present invention;

FIG. 4 shows the ghost touches and real touches detected by self-capacitance of a preferred embodiment of the present invention;

FIG. 5 is a schematic diagram of a row projection list and a column projection list formed and corresponding ghost palm blocks and real palm blocks of a preferred embodiment of the present invention;

FIG. 6 is a schematic diagram of ghost touches filtered out from all the possible touches by means of mutual capacitance detection of a preferred embodiment of the present invention; and

FIG. 7 is a schematic diagram of real palm blocks and sensed signals of intended inputs outside the rectangular palm block and within the rectangular palm block yet beyond the real palm block of a preferred embodiment of the present invention.

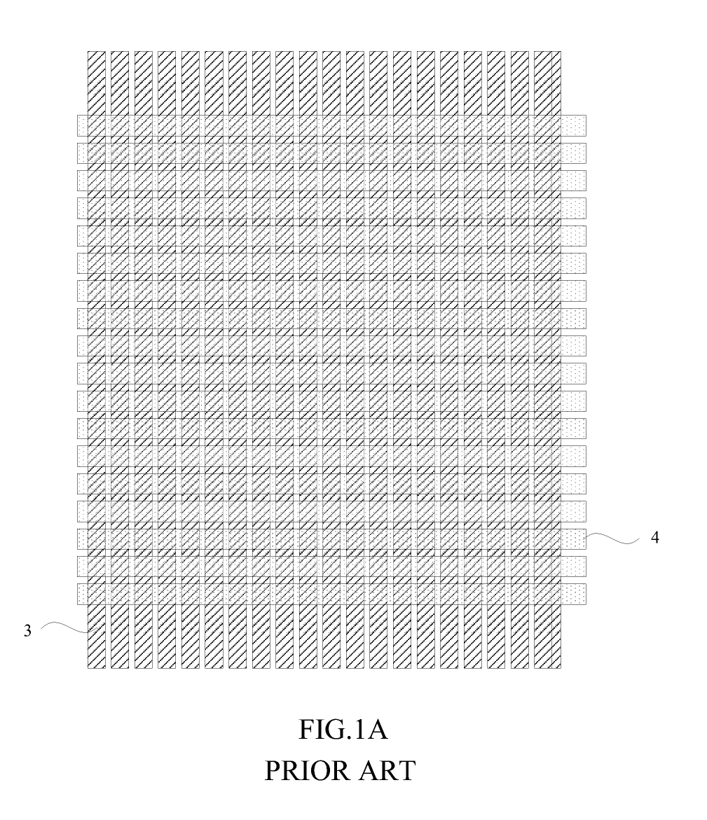

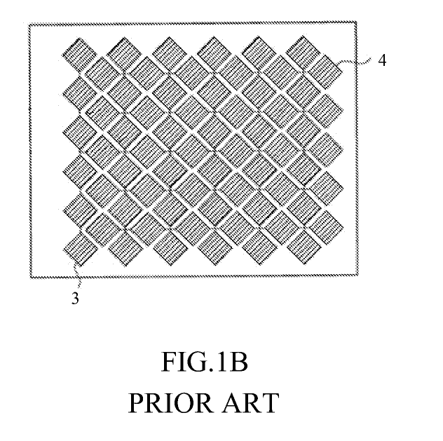

### DETAILED DESCRIPTION OF THE INVENTION

The following embodiments are described with reference to the following accompanying drawings which exemplify the realizations of this invention.

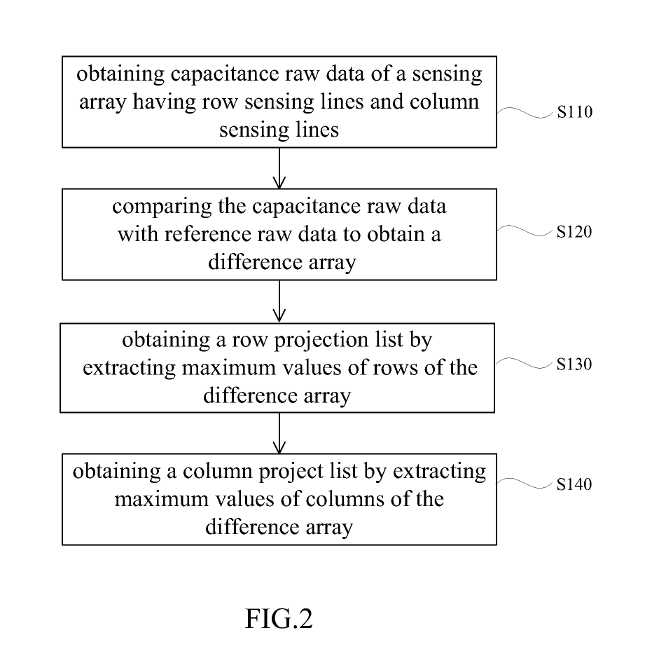

Referring to FIG. 2, FIG. 2 is a flowchart of the method of reducing computation of palm rejection by projecting touch data of a preferred embodiment of the present invention. The present invention targets the handheld devices, and the sizable reduction of the computation of the palm rejection proves in the following embodiments to enable the computational algorithm of the method to build into the touch panel control chip (not shown in the figure). The method 10 of the present invention comprises the following steps:

STEP 1 (S110): obtaining capacitance raw data of a sensing array having row sensing lines and column sensing lines;

STEP 2 (S120): comparing the capacitance raw data with reference raw data to obtain a difference array;

STEP 3 (S130): obtaining a row projection list by extracting maximum values of rows the difference array; and

STEP 4 (S140): obtaining a column project list by extracting maximum values of columns of the difference array.

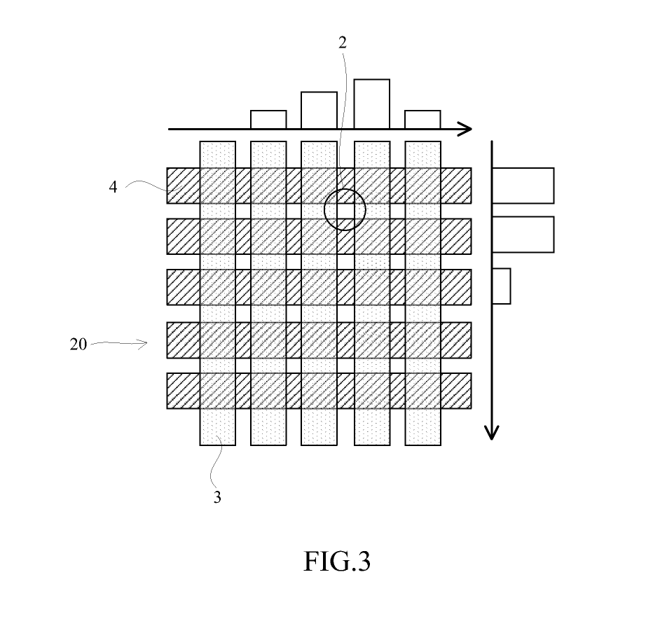

Referring to FIG. 3, FIG. 3 is a schematic diagram of the raw data matrix detected by self-capacitance of a preferred embodiment of the present invention. As in FIG. 3, the present embodiment is a method 10 of reducing computation of palm rejection by projecting touch data, and the raw data matrix 20 is made up of plural row sensing lines 3 and plural column sensing lines 4. The self-capacitance hereto refers to the capacitance coupling occurred by the interaction of a touching object and the sensing lines in the proximity. The self-capacitance approach detects capacitance variances of the sensing lines to determine the possible locations of the touches. Likewise, once a tap 2 by a finger occurs on a touchscreen, the self-capacitances of the row sensing lines 3 and the column sensing lines 4 in the proximity will be lifted, and the possible locations of the touches can then be tracked.

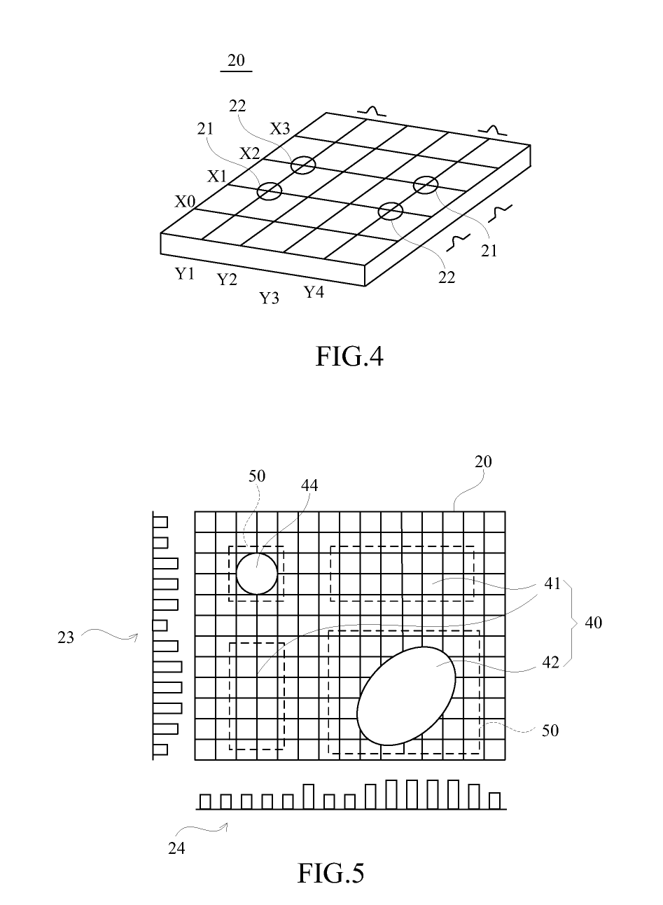

Referring to FIG. 4, FIG. 4 shows the ghost touches and real touches detected by the self-capacitance approach of a preferred embodiment of the present invention. In the embodiment, the self-capacitance touchscreen technology is exemplified by the cross arrangement of row sensing lines Y1-Y4 and column sensing lines X0-X3. During the detection of the touches, a touch panel controller (not shown in the figure) will scan the row sensing lines Y1-Y4 and column sensing lines X0-X3 where the row sensing lines Y1 and Y4 and column sensing lines X1 and X2 related to the touches will give rise to pulses that are shown in the top and right of the FIG. 4, which are the outcome of the capacitance couplings occurred between a touching object and those sensing lines, and the intersections of two row sensing lines Y1, Y4 and two column sensing lines X1, X2 are the possible locations of the touches. By means of a specific prior computational algorithm, the possible locations of the touches can be recognized; however, the precise detection of the real locations of the touches still remains unsettled for the self-capacitance approach.

As in FIG. 4, two touches (not shown in the figure) by a touching object bring about a pulse at each of the row sensing lines Y1, Y4 and a pulse at each of the two column sensing lines X1, X2. The intersections of the two sets of pulses constitute four touches, among which two are ghost touches 21 and the other two are real touches 22. The two ghost touches 22 inevitably cause difficulty in detection by the touch panel system.

Referring to FIG. 5, FIG. 5 is a schematic diagram of a row projection list and a column projection list formed and corresponding ghost palm blocks and real palm blocks of a preferred embodiment of the present invention. In the embodiment, a difference matrix is obtained by subtracting a calibrated raw data matrix from the raw data matrix 20 of sensed signals, and the calibrated raw data matrix is a capacitance matrix computed by a statistic model with static and dynamic calibration under the conditions of no touches and palm blocks; the static calibration is capable of adjusting difference between touchscreens while the dynamic calibration is capable of tracking the variances of temperature and humidity.

In the embodiment, the row projection list 23 and the column projection list 24 are formed by the difference matrix (not shown in the figure), and the row palm mask 231 (not shown in the figure) and the column palm mask 241 (not shown in the figure) are the outcome of comparison between each projected member of row projection list 23 or each projected member of column projection list 24 with a palm threshold 30 respectively; the corresponding row palm mask 231 or column palm mask 241 equals to 1 if a sensing line exceeds the palm threshold; otherwise, the corresponding row palm mask 231 or column palm mask 241 equals to 0 if a sensing line lowers than the palm threshold.

Referring again to FIG. 5, in an embodiment of this invention, the step of determining palm blocks 40 by the row palm mask 231 and the column palm mask 241 can be achieved, provided that the number of the adjoined row sensing lines in the palm block 50 is greater than a threshold-row and the number of the adjoined column sensing lines in the palm block 50 is greater than a threshold-column, the sensed signals 42, 44 generated in the palm block are filtered out or neglected. However, to those skilled in the art, the threshold-row and threshold-column can be different constant values, subject to the requirements of specific applications for different purposes or different nations in the world.

Referring again to FIG. 5, in an embodiment of this invention, to determine palm blocks 40 by the row palm mask 231 and the column palm mask 241 can be achieved, provided that the number of the adjoined row sensing lines in the palm block multiplied by the number of the adjoined column sensing lines in the palm block is greater than a threshold-area, the sensed signals generated in the palm block are filtered out or neglected. To those skilled in the art, the determination of palm blocks 40 can also be achieved by way of the row projection list 23 and the column projection list 24.

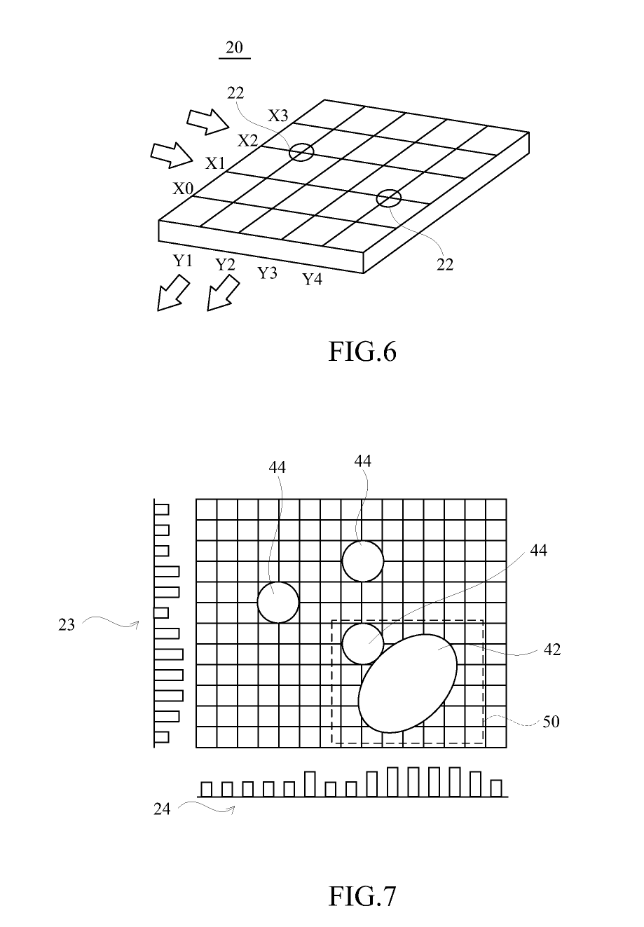

Referring to FIGS. 4, 5 and 6, FIG. 6 is a schematic diagram of ghost touches filtered out from all the possible touches by means of mutual capacitance detection of a preferred embodiment of the present invention. In an embodiment of this invention, it is the implementing of mutual capacitance detection that can filter out ghost touches 21 from all the possible touches where the ghost touches 21 are brought by the self-capacitance detection, shown in FIGS. 4 and 6.The way to reject the ghost touches 21 is through the projection of each of the possible touches individually, which is to acquire maximum values of a difference matrix for each of the possible touches, from which a column projection list and a row projection list for each touch are obtained. And a column palm mask or a row palm mask for each touch is obtained by comparing the column projection list or row projection list with its corresponding palm threshold. Once the detection of each of the touches is accomplished, the ghost touches 21 can be wiped out, and the real touches 22 are identified. The other issue of the projection coverage of one another for the touches can also be eliminated considerably. By means of recursive principle, the area of palm block 40 to be detected is reduced gradually until the length and width of the palm block 40 equal to the corresponding palm-height and palm-width values, or the area of the palm block 40 is identical to the corresponding palm-area value, the ghost palm blocks 41 can then be excluded.

FIG. 7 is a schematic diagram of real palm blocks and sensed signals of intended inputs outside the rectangular palm block and within the rectangular palm block yet beyond the real palm block of a preferred embodiment of the present invention. In an embodiment of this invention, the step of detecting the sensed signals 44 of the intended inputs fallen within the rectangular palm blocks 50 yet beyond real palm blocks 42 is executed by means of combining local spatial boundary detection algorithm; therefore, the present invention further works as a preprocessing system of the palm rejection to avoid the rejection of the sensed signals of intended inputs. The real palm blocks 42 are identified through the recursive principle to decrease the extent of each palm block 50, the ghost palm block can be wiped out. The sensed signals 44 included in the rectangular palm block 50 yet beyond the real palm block 42 can be distinguished by means of combining a local spatial boundary detection algorithm. Accordingly, the issue of the sensed signals 44 of intended input that was wiped off together can be substantially improved. The sensed signals 44 outside of the rectangular palm block 50 can be identified during the implementing the mutual capacitance detection.

In general, although a few embodiments of the present invention have been disclosed, the above preferred embodiments are not used for limiting this invention, and it will be understood by those of ordinary skill in the art that various changes in form and details may be made therein without departing from the spirit and scope of the present invention.

What is claimed is:

1. A method of reducing computation of palm rejection by projecting touch data, the method comprising steps of:
obtaining capacitance raw data of a sensing array having row sensing lines and column sensing lines;
comparing the capacitance raw data with reference raw data to obtain a difference array;
obtaining a row projection list by extracting maximum values of rows the difference array; and
obtaining a column project list by extracting maximum values of columns of the difference array.

2. The method of reducing computation of palm rejection by projecting touch data as claimed in claim 1, wherein the current raw data of the sensing array are obtained by measuring self-capacitances of the respective row sensing lines and the respective column sensing lines.

3. The method of reducing computation of palm rejection by projecting touch data as claimed in claim 1, wherein the current raw data of the sensing array are obtained by measuring mutual capacitances between the row sensing lines and the column sensing lines.

4. The method of reducing computation of palm rejection by projecting touch data as claimed in claim 1, wherein the reference raw data comprises a capacitance matrix computed by a statistic model under a condition that no touch or palm block event occurs on the sensing array.

5. The method of reducing computation of palm rejection by projecting touch data as claimed in claim 4, wherein the reference raw data is computed by using a static calibration procedure.

6. The method of reducing computation of palm rejection by projecting touch data as claimed in claim 4, wherein the reference raw data is computed by using a dynamic calibration procedure.

7. The method of reducing computation of palm rejection by projecting touch data as claimed in claim 1, further comprising a step of determining at least one rectangular palm block by the row projection list and the column projection list.

8. The method of reducing computation of palm rejection by projecting touch data as claimed in claim 7, wherein the step of determining at least one rectangular palm block by the row projection list and the column projection list is to compare the row projection list with a first palm threshold and compare the column projection list with a second palm threshold respectively to form a row palm mask and a column palm mask to determine an extent of the palm block.

9. The method of reducing computation of palm rejection by projecting touch data as claimed in claim 8, wherein the corresponding row palm mask or column palm mask equals to 1 if a sensed signal of a sensing line in the palm block exceeds the palm threshold; otherwise, the corresponding row palm mask or column palm mask equals to 0 if a sensed signal of a sensing line in the palm block lowers than the palm threshold.

10. The method of reducing computation of palm rejection by projecting touch data as claimed in claim 9, wherein if the number of the adjoined row sensing lines in the palm block is greater than a row-threshold and the number of the adjoined column sensing lines in the palm block is greater than a column-threshold, the sensed signals generated in the palm block are filtered out or neglected.

11. The method of reducing computation of palm rejection by projecting touch data as claimed in claim 9, wherein the number of the adjoined row sensing lines in the palm block multiplied by the number of the adjoined column sensing lines in the palm block is greater than an area-threshold, the sensed signals generated in the palm block are filtered out or neglected.

12. The method of reducing computation of palm rejection by projecting touch data as claimed in claim 1, further comprising a step of filtering out ghost palm blocks from the rectangular palm blocks one after the other, which is accomplished by filtering out ghost palm blocks from the plurality of palm blocks by means of mutual capacitance detection.

13. The method of reducing computation of palm rejection by projecting touch data as claimed in claim 1, further comprising: detecting the sensed signals fallen within the rectangular palm blocks yet beyond real palm blocks by means of combining a local spatial boundary detection algorithm.
